(19) United States
(12) Patent Application Publication
(10) Pub. No.: US 2014/0134998 A1
(43) Pub. Date: May 15, 2014

(54) SIGNAL DETECTION METHOD FOR COMMUNICATION APPARATUS AND SIGNAL DETECTION SYSTEM

(71) Applicant: ASKEY COMPUTER CORP., New Taipei City (TW)

(72) Inventor: Hsiu-Li Wang, Keelung City (TW)

(73) Assignee: ASKEY COMPUTER CORP., New Taipei City (TW)

(21) Appl. No.: 13/759,066

(22) Filed: Feb. 5, 2013

(30) Foreign Application Priority Data
Nov. 9, 2012 (TW) 101141856

(51) Int. Cl. H04W 24/06

(52) U.S. Cl. CPC H04W 24/06
USPC 455/425

(57) ABSTRACT

A signal detection method for a communication apparatus and a signal detection system are provided. The signal detection method is suitable for controlling a test apparatus through an electronic apparatus to run a test on the communication apparatus. In the signal detection method, a designated test apparatus option corresponding to a designated test apparatus is selected from plural test apparatus options. A designated communication protocol is selected from plural wireless communication protocols. A test request is generated according to a model of the designated test apparatus and the designated communication protocol. The test request is transmitted to the designated test apparatus, so that the designated test apparatus performs an initialization process. The designated test apparatus is controlled to perform a signal detection process on the communication apparatus, so that the designated test apparatus generates a detection result. The detection result is received from the designated test apparatus and stored.

### CROSS-REFERENCE TO RELATED APPLICATION

This application claims the priority benefit of Taiwan application serial no. 101141856, filed on Nov. 9, 2012. The entirety of the above-mentioned patent application is hereby incorporated by reference herein and made a part of this specification.

### BACKGROUND OF THE INVENTION

1. Field of the Invention

The invention relates to a signal detection technology, and more particularly to a signal detection method for a communication apparatus and a signal detection system.

2. Description of Related Art

During the research and development stage of communication apparatuses, functional tests are required to be performed on the developing products, so as to ensure that the finished products comply with regulations and standards stipulated by the European Telecommunication Standard Institute (ETSI). Conventional test apparatuses commonly known to the industry include the CMU200 communication tester or the CMW500 communication tester produced by Rohde & Schwarz (R& S) Ltd. or the Agilent 8960 wireless communication test set manufactured by Agilent Technologies Inc., and these test apparatuses require manual operation.

In order to guarantee compatibility and stability of wireless communication apparatuses manufactured by various manufacturers and enable the communication apparatuses to comply with quality standards set forth by the manufacturers themselves before the communication apparatuses are packed and shipped, inspectors need to manually run tests on these communication apparatuses at different frequency bands with use of different test apparatuses according to different communication protocols. Nonetheless, the manual detection of the communication apparatuses consumes significant labor and time; therefore, most manufacturers strive for streamlining the test and detection procedure of the communication apparatuses.

### SUMMARY OF THE INVENTION

An embodiment of the invention is directed to a signal detection method for a communication apparatus and a signal detection system which may automate the signal detection process, so as to rapidly evaluate the communication quality of the communication apparatus.

In an embodiment of the invention, a signal detection method for a communication apparatus is provided, and the signal detection method is applicable to an electronic apparatus. The signal detection method includes following steps. A designated test apparatus option is selected from a plurality of test apparatus options, and the designated test apparatus option corresponds to a designated test apparatus that is respectively coupled to the electronic apparatus and the communication apparatus. A designated communication protocol is selected from a plurality of wireless communication protocols, and the communication apparatus supports the designated communication protocol. A test request is generated according to a model of the designated test apparatus and the designated communication protocol. The test request is transmitted to the designated test apparatus, such that the designated test apparatus performs an initialization process. The designated test apparatus is controlled to perform a signal detection process on the communication apparatus, such that the designated test apparatus generates a detection result. The detection result is received from the designated test apparatus and stored.

According to an embodiment of the invention, the signal detection method further includes transmitting a suspension command to the designated test apparatus, such that the designated test apparatus suspends the signal detection process. A temporary test file is received from the designated test apparatus, and the temporary test file records a suspension time point of the signal detection process. A suspension termination command is transmitted to the designated test apparatus, such that the designated test apparatus continues to perform the signal detection process from the suspension time point.

According to an embodiment of the invention, after the test request is transmitted to the designated test apparatus and accordingly the initialization process is performed by the designated test apparatus, the signal detection method further includes transmitting a setting command to the designated test apparatus, such that the designated test apparatus selects a test frequency band from a plurality of test frequency bands and sets a plurality of test threshold values.

According to an embodiment of the invention, the step of controlling the designated test apparatus to perform the signal detection process on the communication apparatus and generating the detection result by the designated test apparatus includes controlling the designated test apparatus to perform a bit error rate (BER) test and an Rx quality indicator test on the communication apparatus at the selected test frequency band and determining whether the detection result is a pass result or a fail result according to the test threshold values.

According to an embodiment of the invention, the test threshold values are standard values of a plurality of test parameters, and the test parameters include at least one of or a combination of cable loss, a BER, and an Rx quality indicator.

According to an embodiment of the invention, after the test request is transmitted to the designated test apparatus and the initialization process is performed by the designated test apparatus, the signal detection method further includes transmitting a calling command to the designated test apparatus, such that the designated test apparatus establishes a calling channel with the communication apparatus as well as communicates with the communication apparatus at the selected test frequency band and transmits a calling result back to the electronic apparatus.

According to an embodiment of the invention, the electronic apparatus transmits the test request to the designated test apparatus and receives the detection result from the designated test apparatus through a general purpose instrumentation bus (GPIB).

In an embodiment of the invention, a signal detection system that includes a communication apparatus, a designated test apparatus, and an electronic apparatus is provided. The designated test apparatus is coupled to the communication apparatus. The electronic apparatus is coupled to the designated test apparatus and performs a signal detection process on the communication apparatus through the designated test apparatus. The electronic apparatus includes a storage unit, a connection unit, and a processing unit. The storage unit stores a plurality of programming code snippets. The processing unit is coupled to the storage unit and the connection unit and performs the signal detection method through the programming code snippets. A designated test apparatus option is selected from a plurality of test apparatus options, and the designated test apparatus option corresponds to the designated test apparatus. A designated communication protocol is selected from a plurality of wireless communication protocols, and the communication apparatus supports the designated communication protocol. A test request is generated according to a model of the designated test apparatus and the designated communication protocol, and the test request is transmitted to the designated test apparatus through the connection unit, such that the designated test apparatus performs an initialization process. The designated test apparatus is controlled to perform a signal detection process on the communication apparatus, such that the designated test apparatus generates a detection result, and the detection result is received from the designated test apparatus through the connection unit and is stored.

According to an embodiment of the invention, the processing unit transmits a suspension command to the designated test apparatus through the connection unit, such that the designated test apparatus suspends the signal detection process; the processing unit receives a temporary test file from the designated test apparatus through the connection unit, and the temporary test file records a suspension time point of the signal detection process; when the processing unit transmits a suspension termination command to the designated test apparatus through the connection unit, the designated test apparatus continues to perform the signal detection process from the suspension time point.

According to an embodiment of the invention, the processing unit transmits a setting command to the designated test apparatus through the connection unit, such that the designated test apparatus selects a test frequency band from a plurality of test frequency bands and sets a plurality of test threshold values.

According to an embodiment of the invention, the electronic apparatus controls the designated test apparatus to perform a bit error rate (BER) test and an Rx quality indicator test on the communication apparatus at the selected test frequency band and determine whether the detection result is a pass result or a fail result according to the test threshold values.

According to an embodiment of the invention, the test threshold values are standard values of a plurality of test parameters, and the test parameters include at least one of or a combination of cable loss, a BER, and an Rx quality indicator.

According to an embodiment of the invention, the electronic apparatus transmits a calling command to the designated test apparatus, such that the designated test apparatus establishes a calling channel with the communication apparatus as well as communicates with the communication apparatus at the selected test frequency band and transmits a calling result back to the electronic apparatus.

In view of the above, the electronic apparatus performs a signal detection process on the communication apparatus through the designated test apparatus. Specifically, the electronic apparatus may enable the designated test apparatus to perform the signal detection process according to the model of the designated test apparatus and the designated communication protocol supported by the communication apparatus, and the designated test apparatus may thereby generate a detection result. The electronic apparatus further receives the detection result from the designated test apparatus. As a result, the electronic apparatus applied for automating the signal detection process is conducive to the reduction of the test time and the improvement of the efficiency of signal detection.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a signal detection system according to an embodiment of the invention.

FIG. 2 is a flowchart illustrating a signal detection method for a communication apparatus according to an embodiment of the invention.

FIG. 3 is a schematic diagram illustrating a signal detection process according to an embodiment of the invention.

### DETAILED DESCRIPTION OF DISCLOSED EMBODIMENTS

In a normal signal detection system, different test instruments are often applied to run tests on a communication apparatus. Besides, if the detection process includes time-consuming tests (e.g., a sensitivity test), or the detection process is required to be performed at different test frequency bands, the detection process often consumes significant time. Hence, the improvement of efficiency of the signal detection process on the communication apparatus is bound to reduce the labor costs and the time spent on the tests, and thus a signal detection method and a signal detection system are provided herein. In order to make the invention more comprehensible, embodiments are described below as examples to demonstrate that the invention can actually be realized.

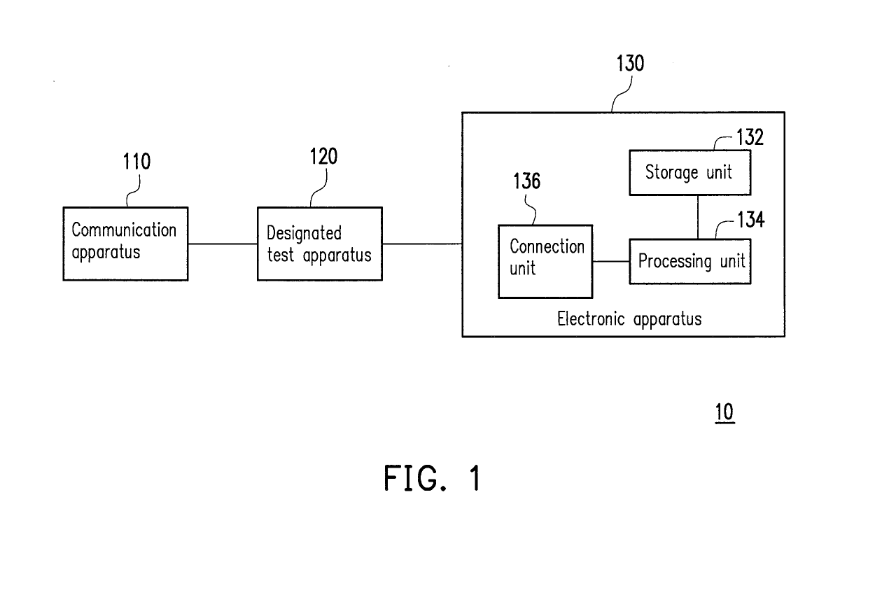

FIG. 1 is a block diagram illustrating a signal detection system according to an embodiment of the invention. With reference to FIG. 1, a signal detection system 10 includes a communication apparatus 110, a designated test apparatus 120, and an electronic apparatus 130. In this embodiment, the electronic apparatus 130 performs a signal detection process on the communication apparatus 110 through the designated test apparatus 120.

The communication apparatus 110 is, for instance, a cell phone, a personal digital assistant (PDA), a smart phone, a pocket PC, a tablet PC, or a notebook computer where communication software is already installed. In brief, the communication apparatus 110 may be any portable mobile apparatus capable of performing communication functions, and the type of the communication apparatus 110 is not limited in the present embodiment.

The designated test apparatus 120 is coupled to the communication apparatus 110. Note that the designated test apparatus 120 may simulate a variety of wireless communication protocols, and these wireless communication protocols include but are not limited to a code division multiple access (CDMA) system, a wideband code division multiple access (WCDMA) system, a time division synchronous code division multiple access (TD-SCDMA) system, a groupe speciale mobile (GSM) system, a worldwide interoperability for microwave access (WiMAX) system, a global positioning system (GPS), a Bluetooth system, a wireless LAN system, a personal handy-phone system (PHS), a digital video broadcasting (DVB) system, and so forth. According to the wireless communication protocol of the communication apparatus 110, the designated test apparatus 120 described in this embodiment is able to inspect sensitivity, total radiated power (TRP), total isotropic sensitivity (TIS), transmission quantity, or hand-over of the communication apparatus 110, so as to verify the communication quality of the communication apparatus 110 and generate a detection result; however, the invention is not limited thereto.

It should be mentioned that the designated test apparatus 120 may receive a plurality of commands from the electronic apparatus 130 and run tests on the communication apparatus 110 according to these commands. Besides, the designated test apparatus 120 described in the present embodiment may refer to a communication tester (e.g., CMU200 or CMW500) produced by Rohde & Schwarz (R & S) Ltd., a wireless communication test set (e.g., Agilent 8960) manufactured by Agilent Technologies Inc., or any other appropriate simulator and/or radio frequency (RF) tester, for instance.

The electronic apparatus 130 is coupled to the designated test apparatus 120 and performs a signal detection process on the communication apparatus 110 through the designated test apparatus 120. Here, the electronic apparatus 130 includes a storage unit 132, a processing unit 134, and a connection unit 136, and the processing unit 134 is coupled to the storage unit 132 and the connection unit 136.

In particular, the storage unit 132 may store a plurality of self-defined programming code snippets, and the storage unit 132 may also store test parameters required by the designated test apparatus 120 for running tests on the communication apparatus 110, test threshold values, detection results, etc. Through the programming code snippets, the processing unit 134 may sequentially run the tests one by one and execute the test commands in the programming code snippets. These test commands executed in a particular order collectively constitute an automated signal detection process to be performed on the communication apparatus 110. The processing unit 134 may further receive the detection result from the designated test apparatus 120 through the connection unit 136. Here, the connection unit 136 is a general purpose instrumentation bus (GPIB), for instance, and the electronic apparatus 130 is coupled to the designated test apparatus 120 through the GPIB and a GPIB cable, for instance.

In the present embodiment, the electronic apparatus 130 is coupled to the designated test apparatus 120 through the connection unit 136, so as to control the designated test apparatus 120 to run tests on the communication apparatus 110 and thereby carry out each step in the signal detection method described in the present embodiment. The electronic apparatus 130 is, for instance, a personal computer, a notebook computer, a thin client (TC), or a server, and the type of the electronic apparatus 130 is not limited herein. The electronic apparatus 130 selects a designated test apparatus option from a plurality of test apparatus options. Each of the test apparatus options corresponds to one of the test apparatuses, respectively, and the designated test apparatus option corresponds to the designated test apparatus 120. A user may select the designated test apparatus option; alternatively, the electronic apparatus 130 may automatically select the designated test apparatus option from a plurality of test apparatus options, and the designated test apparatus option corresponds to the designated test apparatus 120 that is coupled to the electronic apparatus 130.

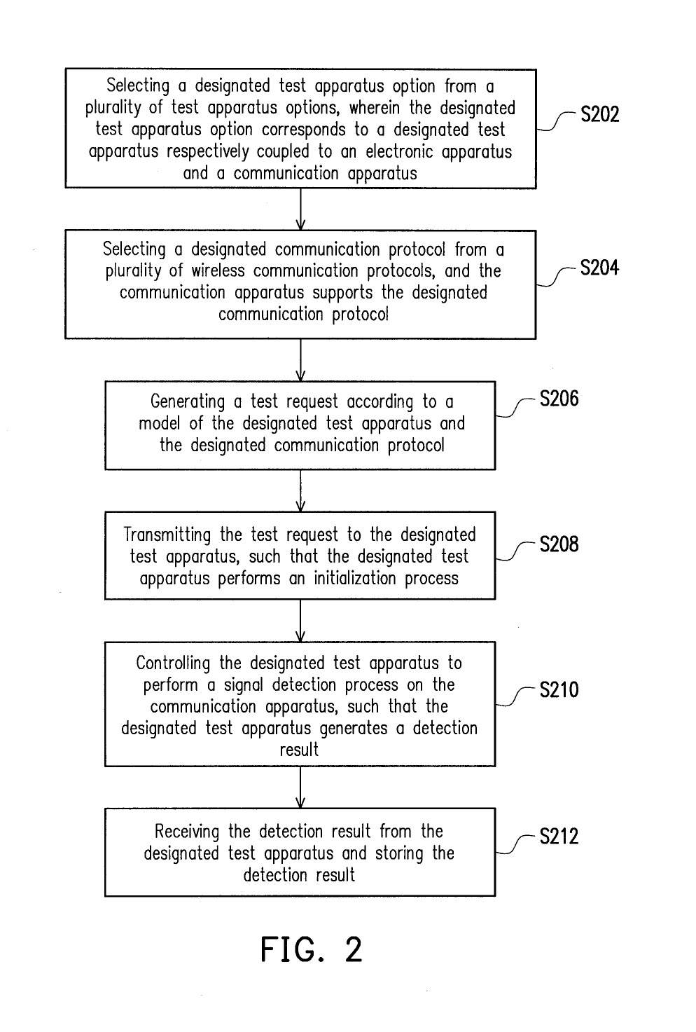

The signal detection method for a communication apparatus is described hereinafter with reference to the above-mentioned signal detection system 10. FIG. 2 is a flowchart illustrating a signal detection method for a communication apparatus according to an embodiment of the invention. The signal detection method described herein is applicable to the electronic apparatus 130 which may perform a signal detection process on the communication apparatus 110 through the designated test apparatus 120. For instance, the electronic apparatus 130 may, through the processing unit 134 in the electronic apparatus 130, execute the programming code snippets to control the designated test apparatus 120.

With reference to FIG. 1 and FIG. 2, in step S202, the electronic apparatus 130 selects a designated test apparatus option from a plurality of test apparatus options. Each of the test apparatus options exemplarily corresponds to one of the test apparatuses, respectively, and the test apparatus options respectively correspond to the programming code snippets supported by different test apparatuses. Thereby, before the signal detection method is conducted, the electronic apparatus 130 may automatically determine the designated test apparatus 120 coupled thereto and accordingly select the corresponding designated test apparatus option for executing the corresponding programming code snippet.

It is also likely for a user to select the designated test apparatus option. For instance, the electronic apparatus 130 may display a test apparatus option menu on a display unit (not shown, e.g., a screen), and the test apparatus option menu may include a plurality of test apparatus options for the user to select. According to the test apparatus selected by the user, the electronic apparatus 130 may select the designated test apparatus 120.

The electronic apparatus 130 may also read a list which records a test order of the test apparatuses. The list may, based on a user's demand, sequentially record the test order of the test apparatuses. According to said list, the electronic apparatus 130 is able to execute the programming code snippets corresponding to different test apparatuses.

The electronic apparatus 130 may further select the test apparatuses that may be applied to run tests on the communication apparatus 110 from a plurality of test apparatuses according to the wireless communication protocol of the communication apparatus 110, the test parameters or threshold values for evaluating the communication quality, or the analysis on the test apparatus options of each test apparatus. The applicable test apparatuses (that may be applied to run tests on the communication apparatus 110) may be listed and displayed on the display unit for the user to select.

In step S204, the electronic apparatus 130 selects a designated communication protocol from a plurality of wireless communication protocols, and the communication apparatus 110 supports the designated communication protocol. Here, the designated communication protocol may correspond to the communication between the communication apparatus 110 and other communication apparatuses, e.g., the 2^{nd}-generation (2G) communication system standard, the 3^{rd}-generation (3G) communication system standard, the 3GPP LTE standard, the 3GPP LTE-Advanced standard, and so on. Note that the invention is not limited thereto. The wireless communication protocols may be displayed on the display unit for the user to select.

The electronic apparatus 130 may also make the selection. For instance, if the wireless communication protocol of the communication apparatus 110 complies with the 2G communication system standard, the designated communication protocol selected by the electronic apparatus 130 complies with the GSM system standard. If the wireless communication protocol of the communication apparatus 110 complies with the 3G communication system standard, the designated communication protocol selected by the electronic apparatus 130 complies with the WCDMA system standard. If the wireless communication protocol of the communication apparatus 110 complies with the 2G mobile telecommunications standard (e.g. cdmaOne) proposed by Qualcomm Inc. in the United States, the designated communication protocol selected by the electronic apparatus 130 complies with the CDMA system standard.

In step S206, the electronic apparatus 130 generates a test request according to a model of the designated test apparatus 120 and the designated communication protocol. The model of the designated test apparatus 120 exemplarily refers to the specification of the designated test apparatus 120 provided by a supplier. The test request is, for instance, a command of running a test on the communication apparatus 110, and the command is issued to the designated test apparatus 120 by the electronic apparatus 130. Besides, in the present embodiment, the electronic apparatus 130 transmits the test request to the designated test apparatus 120 through the connection unit 136.

In step S208, the electronic apparatus 130 transmits the test request to the designated test apparatus 120, such that the designated test apparatus 120 performs an initialization process. In the initialization process, the test parameters required by the designated test apparatus 120 for performing the signal detection process on the communication apparatus 110 are initialized to the default values. Here, the test parameters include cable loss, a bit error rate (BER), an Rx quality indicator, or any other test threshold value. That is, to prevent the designated test apparatus 120 from reading improper test parameters and thereby performing the signal detection process on the communication apparatus 110, the electronic apparatus 130 may, through the initialization process, erase the test parameters set before the detection process. Thereby, the designated test apparatus 120 is able to subsequently perform the signal detection process on the communication apparatus 110 according to the corresponding test parameters.

In step S210, the electronic apparatus 130 controls the designated test apparatus 120 to perform the signal detection process on the communication apparatus 110, such that the designated test apparatus 120 generates a detection result. To be specific, the signal detection process performed on the communication apparatus 110 by the designated test apparatus 120 exemplarily includes but is not limited to a sensitivity test, a phase error test, a BER test, an Rx quality indicator test, a Tx (transmitter) power test, a root mean square error test, a frequency error test, a power-versus-time test, an output radio frequency spectrum (ORFS) test, an Rx level test, and so on. Besides, according to said tests in the signal detection process, the designated test apparatus 120 generates the detection result containing corresponding data.

In step S212, the electronic apparatus 130 receives the detection result from the designated test apparatus 120 and stores the detection result (e.g., in the storage unit 132 of the electronic apparatus 130). The electronic apparatus 130 may also receive the detection result from the designated test apparatus 120 through the connection unit 136. It should be mentioned that the time point at which the electronic apparatus 130 receives the detection result from the designated test apparatus 120 is not limited in the present embodiment; for instance, the electronic apparatus 130 may transmit a suspension command to the designated test apparatus 120 after the designated test apparatus 120 completes the signal detection process and/or before the designated test apparatus 120 completes the signal detection process, so as to obtain the data in the current detection result.

Particularly, the electronic apparatus 130 transmits the suspension command to the designated test apparatus 120, such that the designated test apparatus 120 suspends the signal detection process. Here, the electronic apparatus 130 may transmit the suspension command at the time point determined by the user. The electronic apparatus 130 then receives a temporary test file from the designated test apparatus 120, and the temporary test file records a suspension time point of the signal detection process. Thereafter, the electronic apparatus 130 may also transmit a suspension termination command to the designated test apparatus 120, such that the designated test apparatus 120 continues to perform the signal detection process from the suspension time point.

It is also likely for the electronic apparatus 130 to transmit the suspension termination command at the time point set by the user in advance. For instance, it is assumed that the programming code snippet executed by the electronic apparatus 130 records a suspension function for suspending a BER test. Hence, when the electronic apparatus 130 performs the suspension function, the electronic apparatus 130 automatically transmits the suspension command to the designated test apparatus 120, such that the designated test apparatus 120 suspends the BER test. At this time, the electronic apparatus 130 receives the temporary test file from the designated test apparatus 120, and the temporary test file corresponds to the BER test. Here, the temporary test file may record the time point at which the designated test apparatus 120 suspends the BER test, the frequency band at which the designated test apparatus 120 suspends the BER test, the data relevant to the suspension of the BER test, or any other suspension time point. Thereby, when the electronic apparatus 130 transmits the suspension termination command for terminating the suspension of the BER test to the designated test apparatus 120, the designated test apparatus 120 may continue to perform the BER test according to the time point, the frequency band, the data, or any other suspension time point described above.

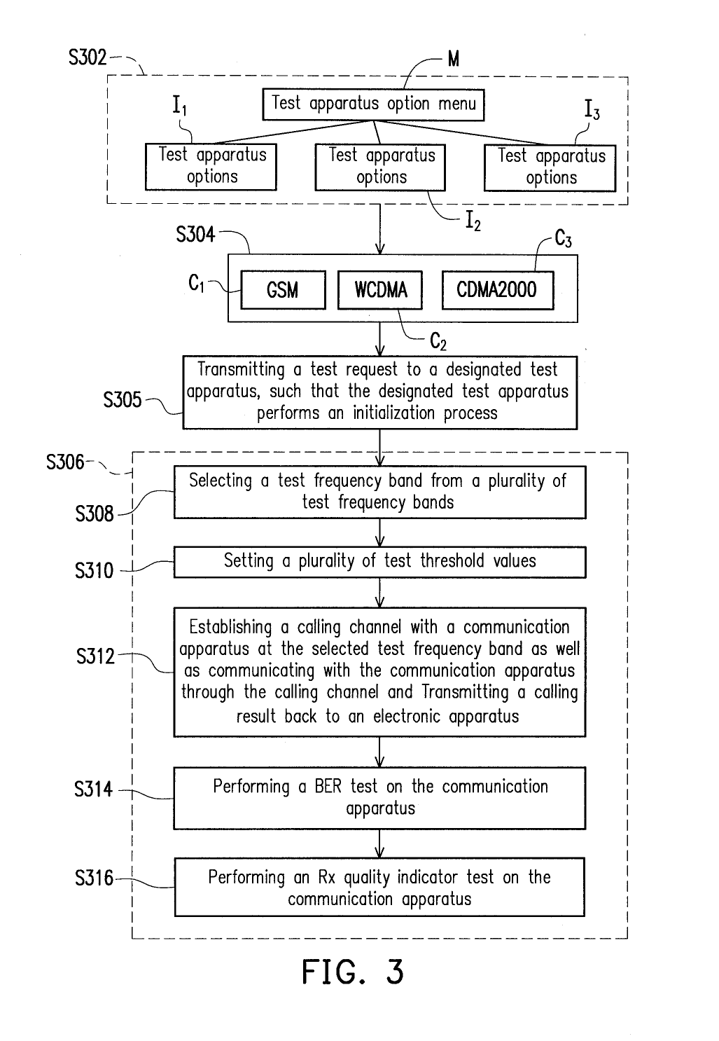

In order to elaborate the signal detection process, another embodiment is provided hereinafter. FIG. 3 is a schematic diagram illustrating a signal detection process according to an embodiment of the invention. The signal detection process is explained with reference to the signal detection system 10 depicted in FIG. 1.

As shown in FIG. 1 and FIG. 3, in step S302, a test apparatus option menu M is displayed by the electronic apparatus 130. The test apparatus option menu M includes three test apparatus options I₁, I₂, and I₃, while the number of the test apparatus options is not limited in practice. The electronic apparatus 130 selects one test apparatus option from the test apparatus options I₁, I₂, and I₃.

For instance, the electronic apparatus 130 may display the test apparatus option menu M on a display unit (not shown, e.g., a screen), such that a user is able to select a designated test apparatus option from the test apparatus options I₁, I₂, and I₃. Here, it is assumed that the test apparatus option I₁ corresponds to the designated test apparatus 120 and serves as the designated test apparatus option.

In step S304, the electronic apparatus 130 selects a designated communication protocol from a plurality of wireless communication protocols, and the communication apparatus 110 supports the designated communication protocol. In particular, the electronic apparatus 130 may display a wireless communication protocol menu on the display unit, such that a user is able to select a designated wireless communication protocol supported by the communication apparatus 110 from the wireless communication protocol menu. The wireless communication protocol menu may include a plurality of wireless communication protocols. In the present embodiment, the wireless communication protocol menu is assumed to include three wireless communication protocols C₁, C₂, and C₃, while the number of the wireless communication protocols in the wireless communication protocol menu is not limited in practice. The wireless communication protocols C₁, C₂, and C₃ exemplarily correspond to GSM, WCDMA, and CDMA2000, respectively.

A user is able to select the wireless communication protocol supported by the communication apparatus 110 from the wireless communication protocol menu. Here, given that the user selects the wireless communication protocol C₁ from the wireless communication protocol menu, the electronic apparatus 130 selects GSM as the designated communication protocol according to the user's selection. Certainly, in another embodiment of the invention, if the user selects the wireless communication protocol C₂ from the wireless communication protocol menu, the electronic apparatus 130 selects WCDMA as the designated communication protocol according to the user's selection. Alternatively, if the user selects the wireless communication protocol C₃ from the wireless communication protocol menu, the electronic apparatus 130 selects CDMA2000 as the designated communication protocol according to the user's selection.

After the steps S302 and S304 are performed, the electronic apparatus 130 generates a test request according to a model of the designated test apparatus 120 and the designated communication protocol. In step S305, the electronic apparatus 130 transmits the test request to the designated test apparatus 120, such that the designated test apparatus 120 performs an initialization process. Other details of the signal detection method are already provided in the previous descriptions of the steps S202 to S208 as shown in FIG. 2 and therefore will no longer be given hereinafter.

In step S306, the electronic apparatus 130 controls the designated test apparatus 120 to perform the signal detection process on the communication apparatus 110. To further clarify the signal detection process, several steps of the signal detection process are explained hereinafter; note that the steps included in the signal detection process and the order of performing these steps are not limited in the present embodiment.

For instance, in step S308, the electronic apparatus 130 transmits a setting command to the designated test apparatus 120, such that the designated test apparatus 120 selects a test frequency band from a plurality of test frequency bands. To be specific, the electronic apparatus 130 may enable the designated test apparatus 120 to select the number of the test frequency bands, determine the range of each test frequency band, or change the intervals among the test frequency bands together with the increase in the test frequency bands. Here, the interval between two test frequency bands is a square root of the corresponding test frequency band, for instance.

Besides, in step S310, the electronic apparatus 130 also transmits the setting command to the designated test apparatus 120, such that the designated test apparatus 120 sets a plurality of test threshold values. According to the present embodiment, the test threshold values are standard values of a plurality of test parameters, and the test parameters include but are not limited to at least one of or a combination of cable loss, a BER, and an Rx quality indicator. For instance, the designated test apparatus 120 may set the BER according to the cable loss.

In step S312, the electronic apparatus 130 transmits a calling command to the designated test apparatus 120, such that the designated test apparatus 120 establishes a calling channel with the communication apparatus 110 at the selected test frequency band as well as communicates with the communication apparatus 110 through the calling channel and transmits a calling result back to the electronic apparatus 130. In particular, if the communication between the designated test apparatus 120 and the communication apparatus 110 is abnormal, the electronic apparatus 130 again transmits the calling command to the designated test apparatus 120, so as to establish another calling channel and determine whether the number of times of establishing the calling channel by the designated test apparatus 120 reaches the upper limit of the number of times of calling actions. If the communication between the designated test apparatus 120 and the communication apparatus 110 is abnormal, and the number of times of establishing the calling channel exceeds the upper limit of the number of times of calling actions, the designated test apparatus 120 transmits a calling result (indicating the abnormal communication) back to the electronic apparatus 130.

In step S314, at the selected test frequency band, the electronic apparatus 130 may issue a command to perform a BER test on the communication apparatus 110; in step S316, the electronic apparatus 130 may also issue a command to perform an Rx quality indicator test on the communication apparatus 110. After the designated test apparatus 120 receives said command, the designated test apparatus 120 may determine whether the detection result of the BER test or the Rx quality indicator test is a pass result or a fail result according to the test threshold values set in the step S310. For instance, the designated test apparatus 120 may obtain the corresponding data after performing the BER test or the Rx quality indicator test, compare the data with the test threshold values, and correspondingly generate the detection result. In the present embodiment, the detection result may be stored as a text file (e.g., in an EXCEL format), an image file (e.g., in a JPG format), or in any other format that may be exported as a form.

In the electronic apparatus 130, a setting interface may be further provided for a user to adjust power during the BER test. For instance, it is assumed that the power required for performing the BER test at three different stages respectively ranges from −70 dBm to −100 dBm, from −100 dBm to −105 dBm, and from −105 dBm to −110 dBm. A user may determine the amplitude of power to be increased for performing the BER test at the three stages, respectively. For instance, when the power required for performing the BER test ranges from −70 dBm to −100 dBm, the amplitude of power is set as −5 dBm through the setting interface; when the power required for performing the BER test ranges from −100 dBm to −105 dBm, the amplitude of power is set as −1 dBm through the setting interface. That is, the power required for performing the BER test at the first time is −70 dBm, and the subsequently required power is −75 dBm, −80 dBm, −85 dBm, . . . , and so on. When the power required for performing the BER test reaches −100 dBm (i.e., the amplitude of power is −1 dBm), the subsequently required power is −101 dBm, −102 dBm, −103 dBm, . . . , and so on.

It should be mentioned that the signal detection process described in the present embodiment is not limited to the BER test and the Rx quality indicator test; in other embodiments, the signal detection process may include the sensitivity test, the phase error test, the Tx power test, the root mean square error test, the frequency error test, the power-versus-time test, the ORFS test, the Rx level test, or other normal signal tests performed on communication apparatuses.

From another perspective, if the designated test apparatus 120 has not yet performed the signal detection process on the communication apparatus 110 at all of the test frequency bands, the electronic apparatus 130 may further continue to perform the signal detection process through the designated test apparatus 120 at another test frequency band. By contrast, if the designated test apparatus 120 has already performed the signal detection process on the communication apparatus 110 at all of the test frequency bands, the electronic apparatus 130 may receive the detection result form the designated test apparatus 120 and store the detection result. It is also likely for the electronic apparatus 130 to present the detection result to the user through a graphical user interface, such that the user may verify the detection result.

To sum up, as described above, the electronic apparatus selects one designated test apparatus to perform the signal detection process on the communication apparatus. Specifically, the electronic apparatus transmits a command to the designated test apparatus, such that the designated test apparatus performs the initialization process and performs the signal detection process on the communication apparatus according to the model of the designated test apparatus and the designated communication protocol, and the designated test apparatus may thereby generate a detection result after the completion of the signal detection process. Thereby, as described above, the signal detection process may be automated, so as to evaluate the communication quality of the communication apparatus, reduce the labor and time required for performing the tests, and enhance the efficiency of the signal detection process on the communication apparatus.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A signal detection method for a communication apparatus, the signal detection method being applicable to an electronic apparatus and comprising:
selecting a designated test apparatus option from a plurality of test apparatus options, wherein the designated test apparatus option corresponds to a designated test apparatus, and the designated test apparatus is respectively coupled to the electronic apparatus and the communication apparatus;
selecting a designated communication protocol from a plurality of wireless communication protocols, wherein the communication apparatus supports the designated communication protocol;
generating a test request according to a model of the designated test apparatus and the designated communication protocol;
transmitting the test request to the designated test apparatus, such that the designated test apparatus performs an initialization process;
controlling the designated test apparatus to perform a signal detection process on the communication apparatus, such that the designated test apparatus generates a detection result; and
receiving the detection result from the designated test apparatus and storing the detection result.

2. The signal detection method as recited in claim 1, further comprising:
transmitting a suspension command to the designated test apparatus, such that the designated test apparatus suspends the signal detection process;
receiving a temporary test file from the designated test apparatus, wherein the temporary test file records a suspension time point of the signal detection process; and
transmitting a suspension termination command to the designated test apparatus, such that the designated test apparatus continues to perform the signal detection process from the suspension time point.

3. The signal detection method as recited in claim 1, after transmitting the test request to the designated test apparatus and performing the initialization process by the designated test apparatus, the signal detection method further comprising:
transmitting a setting command to the designated test apparatus, such that the designated test apparatus performs steps of:
selecting a test frequency band from a plurality of test frequency bands; and
setting a plurality of test threshold values.

4. The signal detection method as recited in claim 3, wherein the step of controlling the designated test apparatus to perform the signal detection process on the communication apparatus and generating the detection result by the designated test apparatus comprises:
controlling the designated test apparatus to perform a bit error rate test and an Rx quality indicator test on the communication apparatus at the selected test frequency band and determining whether the detection result is a pass result or a fail result according to the test threshold values.

5. The signal detection method as recited in claim 4, wherein the test threshold values are standard values of a plurality of test parameters, and the test parameters comprise at least one of or a combination of cable loss, a bit error rate, and an Rx quality indicator.

6. The signal detection method as recited in claim 3, after transmitting the test request to the designated test apparatus and performing the initialization process by the designated test apparatus, the signal detection method further comprising:
transmitting a calling command to the designated test apparatus, such that the designated test apparatus establishes a calling channel with the communication apparatus as well as communicates with the communication apparatus at the selected test frequency band and transmits a calling result back to the electronic apparatus.

7. The signal detection method as recited in claim 1, wherein the electronic apparatus transmits the test request to the designated test apparatus and receives the detection result from the designated test apparatus through a general purpose instrumentation bus.

8. A signal detection system comprising:
a communication apparatus;
a designated test apparatus coupled to the communication apparatus; and
an electronic apparatus coupled to the designated test apparatus, the electronic apparatus performing a signal detection process on the communication apparatus through the designated test apparatus and comprising:
a storage unit storing a plurality of programming code snippets;
a connection unit; and
a processing unit coupled to the storage unit and the connection unit, the processing unit through the programming code snippets performing steps of:
selecting a designated test apparatus option from a plurality of test apparatus options, wherein the designated test apparatus option corresponds to the designated test apparatus;
selecting a designated communication protocol from a plurality of wireless communication protocols, wherein the communication apparatus supports the designated communication protocol;
generating a test request according to a model of the designated test apparatus and the designated communication protocol;
transmitting the test request to the designated test apparatus through the connection unit, such that the designated test apparatus performs an initialization process;
controlling the designated test apparatus to perform a signal detection process on the communication apparatus, such that the designated test apparatus generates a detection result; and
receiving the detection result from the designated test apparatus through the connection unit and storing the detection result.

9. The signal detection system as recited in claim 8, wherein the processing unit transmits a suspension command to the designated test apparatus through the connection unit, such that the designated test apparatus suspends the signal detection process, the processing unit receives a temporary test file from the designated test apparatus through the connection unit, the temporary test file records a suspension time point of the signal detection process, and when the processing unit transmits a suspension termination command to the designated test apparatus through the connection unit, the designated test apparatus continues to perform the signal detection process from the suspension time point.

10. The signal detection system as recited in claim 8, wherein the processing unit transmits a setting command to the designated test apparatus through the connection unit, such that the designated test apparatus selects a test frequency band from a plurality of test frequency bands and sets a plurality of test threshold values.

11. The signal detection system as recited in claim 10, wherein the electronic apparatus controls the designated test apparatus to perform a bit error rate test and an Rx quality indicator test on the communication apparatus at the selected test frequency band and determine whether the detection result is a pass result or a fail result according to the test threshold values.

12. The signal detection system as recited in claim 11, wherein the test threshold values are standard values of a plurality of test parameters, and the test parameters comprise at least one of or a combination of cable loss, a bit error rate, and an Rx quality indicator.

13. The signal detection system as recited in claim 10, wherein the electronic apparatus transmits a calling command to the designated test apparatus, such that the designated test apparatus establishes a calling channel with the communication apparatus as well as communicates with the communication apparatus at the selected test frequency band and transmits a calling result back to the electronic apparatus.
